(19) United States
(12) Patent Application Publication
(10) Pub. No.: US 2006/0095679 A1
(43) Pub. Date: May 4, 2006

(54) Method and apparatus for pushing data into a processor cache

(76) Inventor: Samantha J. Edirisooriya, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/977,830

(22) Filed: Oct. 28, 2004

(51) Int. Cl. G06F 12/00

(52) U.S. Cl. 711/137; 711/141

(57) ABSTRACT

An arrangement is provided for using a centralized pushing mechanism to actively push data into a processor cache in a computing system with at least one processor. Each processor may comprise one or more processing units, each of which may be associated with a cache. The centralized pushing mechanism may predict data requests of each processing unit in the computing system based on each processing unit's memory access pattern. Data predicted to be requested by a processing unit may be moved from a memory to the centralized pushing mechanism which then sends the data to the requesting processing unit. A cache coherency protocol in the computing system may help maintain the coherency among all caches in the system when the data is placed into a cache of the requesting processing unit.

### BACKGROUND

1. Field

The present disclosure relates generally to cache architecture in a computing system and, more specifically, to a method and apparatus for pushing data into a processor cache.

2. Description

The execution time of programs that have large code and/or data footprints is significantly affected by the overhead of retrieving data from the memory system. The memory overhead may substantially increase the total execution time. Modern processors typically implement prefetches in hardware in order to anticipatorily fetch data into the processor caches. Prefetching hardware associated with a processor tracks spatial and temporal access patterns of memory accesses and issues anticipatory requests to system memory on behalf of the processor. This helps in reducing the latency of a memory access when the program executing on the processor actually requires the data. For this disclosure, the word “data” will refer to both instructions and traditional data. Due to the prefetch, the data can be found in cache with a latency that is usually much smaller than system memory access latency. Typically, such prefetching hardware is distributed with each processor. If not all processors (e.g., a digital signal processor (DSP)) in a computing system have prefetching hardware, such processors will not be able to perform hardware-based prefetches. This results in an imbalance of performance among processors.

### BRIEF DESCRIPTION OF THE DRAWINGS

The features and advantages of the present disclosure will become apparent from the following detailed description of the present disclosure in which:

FIG. 1 is a schematic diagram illustrating a single-processor computing system of which the memory controller may actively push data into a cache of the processor;

FIG. 2 is a flowchart illustrating an example process of using a memory controller to push data into a processor cache in a single-processor computing system, assuming MOESI cache protocol is used;

FIG. 3 is a diagram illustrating a multiple-processor computing system of which the memory controller may actively push data into a cache of a processor;

FIGS. 4 and 5 illustrate a flowchart of an example process of using a memory controller to push data into a processor cache in a multiple-processor computing system, assuming MOESI cache protocol is used; and

FIG. 6 is a diagram illustrating a computing system of which a centralized pushing mechanism may be used to actively push data into a cache of a processor.

### DETAILED DESCRIPTION

An embodiment of the present invention comprises a method and apparatus for using a centralized pushing mechanism to push data into a processor cache. For example, a memory controller may be adapted to act as the centralized pushing mechanism to push data into a processor cache in either a single-processor computing system or a multiple-processor computing system. The centralized pushing mechanism may comprise request prediction logic to predict a processor's requests of code/data based on this processor's memory access patterns. The centralized pushing mechanism may also comprise a prefetch data buffer to temporarily store the code/data that is predicted to be desired by a processor. Additionally, the centralized pushing mechanism may further comprise push logic to issue a push request and to actively push the code/data stored in the prefetch data buffer onto a system interconnecting bus. The target processor may accept the push request issued by the centralized pushing mechanism and claim the code/data from the system interconnecting bus. The target processor may either place the code/data into a cache of its own or discard the code/data, according to the state of cache line(s) of the code/data in its own cache and/or in caches of other processors in the system. Moreover, the push request may cause changes to the states of the cache line(s) in all caches in the system to ensure cache coherency.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

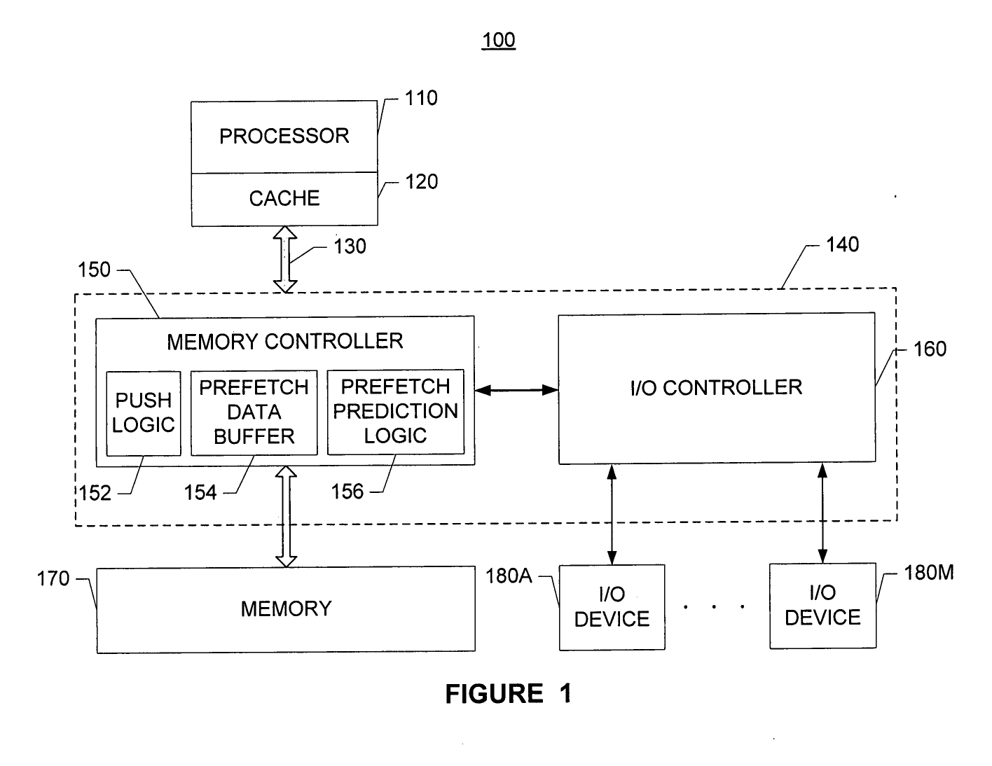

FIG. 1 depicts a single-processor computing system 100 of which the memory controller may actively push data into a cache of the processor. The system 100 comprises processor 110 coupled to an interconnect (e.g. a bus) 130. A cache 120 may be associated with the processor 110. In one embodiment, the processor 110 may be a processor in the Pentium® family of processors including, for example, Pentium® 4 processors, Intel's XScale® processor, Intel's Pentium® M processors, etc., available from Intel Corporation. Alternatively, other processors from other manufacturers may also be used. In another embodiment, the processor 110 may be a digital signal processor (DSP).

A cache 120 may be associated with the processor 110. In one embodiment, the cache 120 may be integrated in the same integrated circuit with the processor. In another embodiment, the cache 120 may be physically separated from the processor. The cache 120 is arranged such that the processor may access code/data faster in the cache than access data in a memory 170 in the system 100. The cache 120 may comprise different levels (e.g., three levels; the processor's access latency to the first level is typically shorter than that to the second or third level; and the processor's access latency to the second level is typically shorter than that to the third level).

The computing system 100 may be coupled with a chipset 140 which may comprise a memory controller 150 (FIG. 1 is a schematic which includes circuits not shown). The memory controller 150 is connected to a memory 170 to handle data traffic to and from the memory 170. The memory 170 may store data that is used or executed by the processor 110 or any other device included in the system. For one embodiment, the main memory 150 may include one or more of dynamic random access memory (DRAM), read-only memory (ROM), Flash memory, etc. The memory controller may be a part of a memory control hub (MCH) (not shown in FIG. 1), which may be coupled to an input/output (I/O) control hub (ICH) (not shown in FIG. 1) via a hub interface. In one embodiment, both the MCH and the ICH may be included in the chipset 140. The ICH may include an I/O controller 160 which provides an interface to I/O devices 180 (e.g., 180A, . . . , 180M) within the computing system 100. I/O devices 180 may be connected to the I/O controller through an I/O bus. Some I/O devices may be connected to the I/O controller 160 via wireless connections.

The memory controller 150 may comprise push logic 152, a prefetch data buffer 154, and prefetch prediction logic 156. The prefetch prediction logic 156 may analyze memory access patterns of the processor 110 (both temporarily and spatially) and predict the processor's future data requests based on the processor's memory access patterns. Based on the prediction by the prefetch prediction logic, the data predicted to be desired by the processor may be moved from the memory 170 and temporarily stored in the prefetch data buffer 154. The push logic may issue a request to the processor to push the data from the prefetch data buffer 154 to the cache 120. A push request may be sent for each cache line of data to be pushed. If the processor 110 accepts the push request, the push logic 152 may put the data on the bus 130 so that the processor may claim the data from the bus; otherwise, the push logic 152 may retry issuing the push request to the processor.

The computing system 100 may run a cache coherency protocol. In one embodiment, a 4-state cache coherency protocol, MESI protocol, may be used. Under the MESI protocol, a cache line may be marked as one of four states: M (Modified), E (Exclusive), S (Shared), and I (Invalidate). The M state of a cache line indicates that this cache line was modified and the underlying data (e.g., corresponding data in the memory) is older than this cache line and thus is no longer valid. The E state of a cache line indicates that this cache line is only stored in this cache and hasn't been changed by a write access yet. The S state of a cache line indicates that this cache line may be stored in other caches of the system. The I state of a cache line indicates that this cache line is invalid. In another embodiment, a 5-state cache coherency, MOESI protocol, may be used. The MOESI protocol has one more state—O(owned)—than the MESI protocol. However, an S state in the MOESI protocol is different from an S state in the MESI protocol. Under an S state with the MOESI protocol, a cache line may be stored in other caches of the system, but was modified and is not consistent with the underlying data in the memory. The cache line can only be modified by one processor and has an O state in this processor's cache, but has an S state in other processors' caches. In the description that follows, the MOESI protocol will be used as an example cache coherency protocol. However, those skilled in the art will appreciate that the same principles can be applied to any other cache coherency protocols such as the MESI and MSI (Modified, Shared, and Invalid) cache coherency protocols.

The bus 130 in the computing system may be a front side bus (FSB) or any other type of system interconnection bus. When the push logic 152 in the memory controller 150 puts data on the bus 130, it also includes a destination identification of the data (“target ID”). A processor (e.g., the processor 110) that is connected to the bus 130 and whose ID matches the target ID of the pushed data may claim the data from the bus. In one embodiment, the bus may have a “push” function, under which the address portion of a bus transaction may include a field indicating whether the “push” function is enabled (e.g., value 1 means enabled and value “0” means disabled); and if the “push” function is enabled, a field or a portion of a field may be used to indicate a destination identification of the pushed data (“target ID”). The bus with the “push” function may also provide a command (e.g., Write_Line) to perform cache line writes on the bus. Thus, when the “push” field is set during a Write_Line transaction, a processor on the bus will claim the transaction if the target ID provided with the transaction matches the processor's own ID. Once the transaction is claimed by the targeted processor, the push logic 152 of the memory controller 150 may provide data from the prefetch data buffer 154 into the cache 120.

When the processor 110 claims the pushed cache line from the bus 130, the processor may or may not decide to place the cache line into the cache 120 such that the cache coherency is not disrupted. The processor 110 needs to check whether the cache line is present in the cache (i.e., whether the data is new to the cache or not). If the cache line is new to the cache 120, the processor may place the cache line into the cache; otherwise, the processor needs to further check the state of the cache line in the cache 120. If the cache line in the cache 120 is in the I state, the processor 110 may replace this cache line with the one claimed from the bus; and otherwise, the processor 110 will discard the claimed cache line without writing it into the cache 120.

Although a single-processor computing system, which may use a memory controller to push data into a processor cache, is illustrated in FIG. 1, a person of ordinary skill in the art will appreciate that a variety of other arrangements may also be utilized.

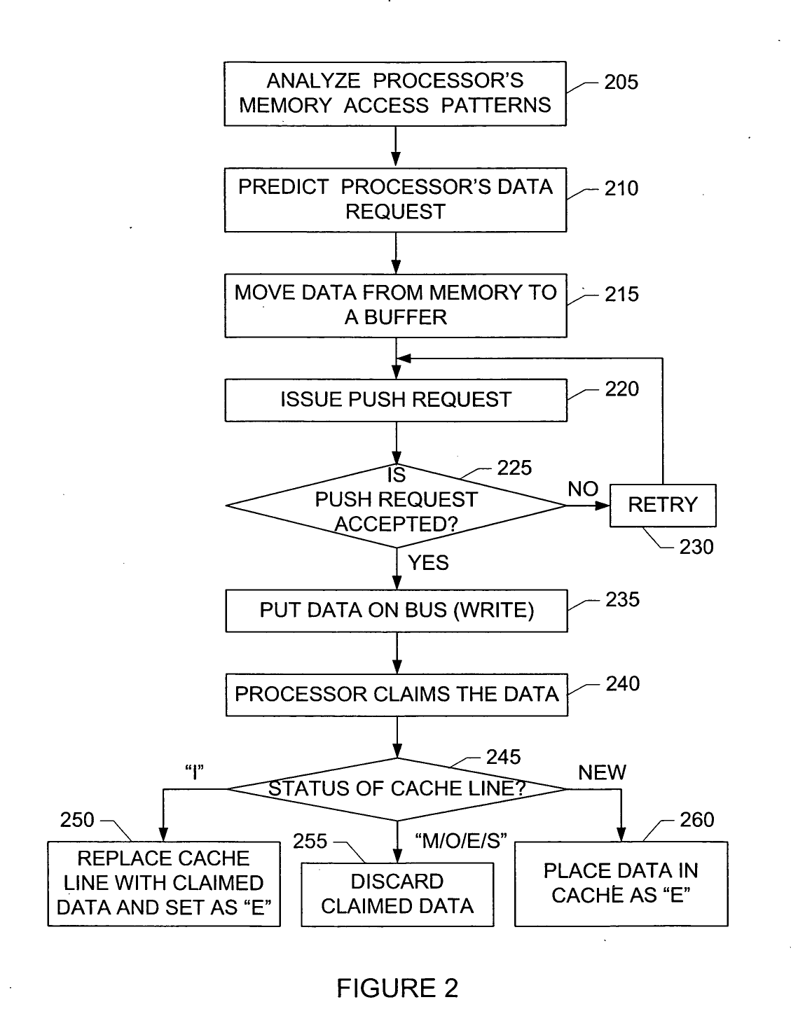

FIG. 2 illustrates an example process of using a memory controller to push data into a processor cache in a single-processor computing system. In block 205, the processor's memory access patterns (both spatially and temporarily) may be analyzed. In block 210, a prediction of the processor's future data requests may be made based on the analysis result obtained in block 205. In block 215, data which will be desired by the processor in the future according to the prediction made in block 210 may be moved from the memory to a buffer in the memory controller (e.g., prefetch data buffer 154 as shown in FIG. 1). In block 220, a request to push the desired data into a cache associated with the processor (e.g., cache 120 as shown in FIG. 1) may be issued. One push request for each cache line of the desired data may be issued.

In block 225, a decision whether the processor accepts the push request issued in block 220 may be made. The “push” field of the cache line write transaction may be set (i.e., the “push” function is enabled) and the target ID may be included in the transaction. This cache line write transaction with “push” may be claimed by the processor if the processor's own ID matches the target ID in the transaction. If the processor does not accept the push request, a retry instruction may be made in block 230 so that the push request may be reissued in block 220. If the processor accepts the push request, a cache line of data to be pushed may be put on a bus, which connects the memory controller and the processor, as a write data transaction in block 235. The target ID may be included in the write data transaction. Here it is assumed that write operation with “push” is executed as a split transaction having a request phase and data phase. However, it is possible to have an interconnect that supports immediate write operation with “push”, where the push data is provided during or immediately after the address (request) phase.

In block 245, the cache of the processor may be checked to see if the claimed cache line is present. If the claimed cache line is new (i.e., not present in the cache) to the cache, on one hand, the claimed cache line is placed in the cache with its state being set as E in block 260. If the claimed cache line is present in the cache, on the other hand, the state of the cache line present in the cache may be further checked. If the state is I (i.e., invalid), this cache line in the cache is replaced with the claimed cache line with its state being set as E in block 250. If the state of the cache line in the cache is M, O, E, or S (i.e., a hit for the processor), the claimed data may be discarded by the processor in block 255, without changing the state of the cache line in the cache.

Although a full cache line push is assumed in the above description, a person of ordinary skill in the art will appreciate the disclosed techniques and readily apply them to any partial cache line push, with or without modifications.

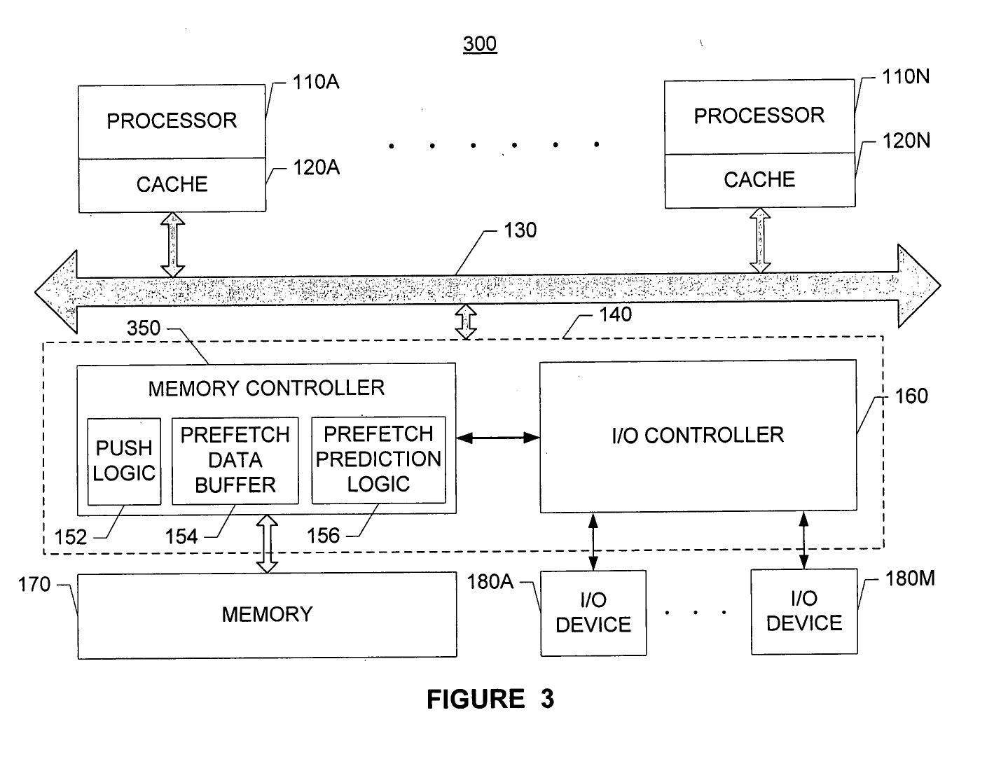

FIG. 3 depicts a multiple-processor computing system 300 of which the memory controller may actively push data into a cache of a processor. The system 300 is similar to the computing system 100 shown in FIG. 1. Unlike the system 100 that comprises a single processor, the system, the system 300 comprises multiple processors, 110A, . . . , 110N. Each processor has a cache (e.g., 120A, . . . , 120N) associated with it. A cache (e.g., 120A) is arranged such that its associated processor can access data in the cache faster than data in the memory 170. All processors are connected to each other through a bus 130 and are coupled, through the bus 130, to a chipset 140 that comprises a memory controller 150 and an I/O controller 160.

The memory controller 150 may comprise push logic 152, a prefetch data buffer 154, and prefetch prediction logic 156. In the system 300, the prefetch prediction logic 156 may analyze memory access patterns (both temporarily and spatially) of all the processors, 110A through 110N, and may predict each processor's future data requests based on its memory access patterns. Based on such predictions, data that is likely be requested by each processor may be moved from the memory 170 and temporarily stored in the prefetch data buffer 154. The push logic may issue a request to push the data from the prefetch data buffer 154 to a cache of a requesting processor. One push request per cache line of data to be pushed may be issued. A push request including the identification of a target processor (“target ID”) may be sent to all processors via the bus 130, but only the targeted processor whose identification matches the target ID needs to respond to the push request. If the targeted processor accepts the push request, the push logic 152 may put the cache line on the bus 130 so that the targeted processor may claim the cache line from the bus; otherwise, the push logic 152 may retry issuing the push request to the targeted processor. When multiple processors are collaborating with each other and performing the same task, the prefetch prediction logic may make a global prediction what data is likely to be needed by all the processors. Based on such a global prediction, data that is likely needed by all the processors may be pushed to caches of all the processors (e.g., the data is broadcasted to all the processors) by the push logic 152.

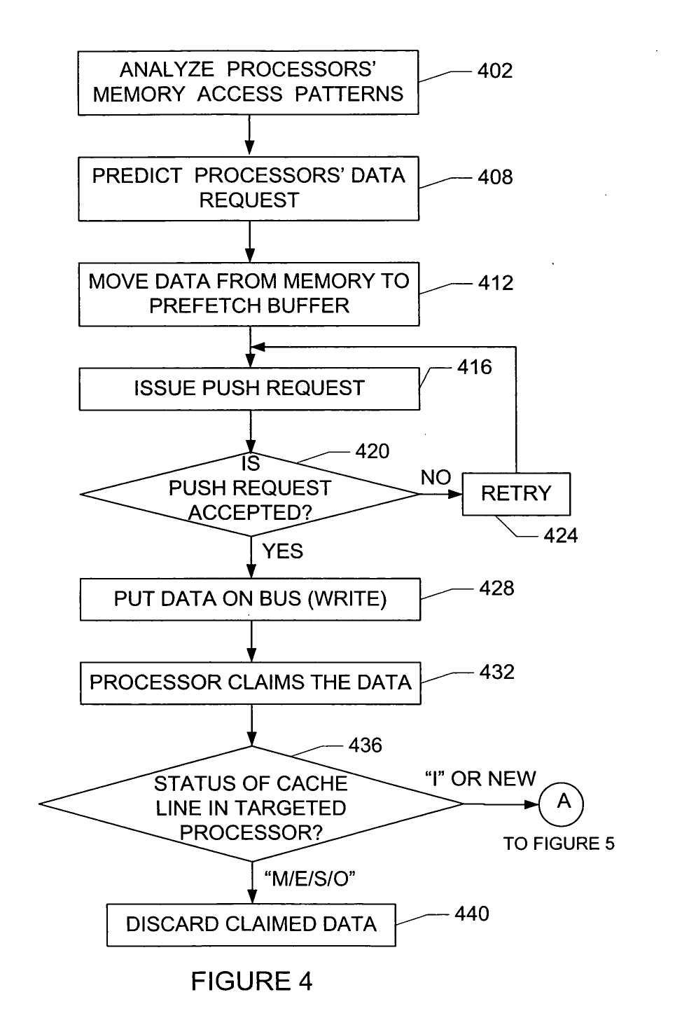

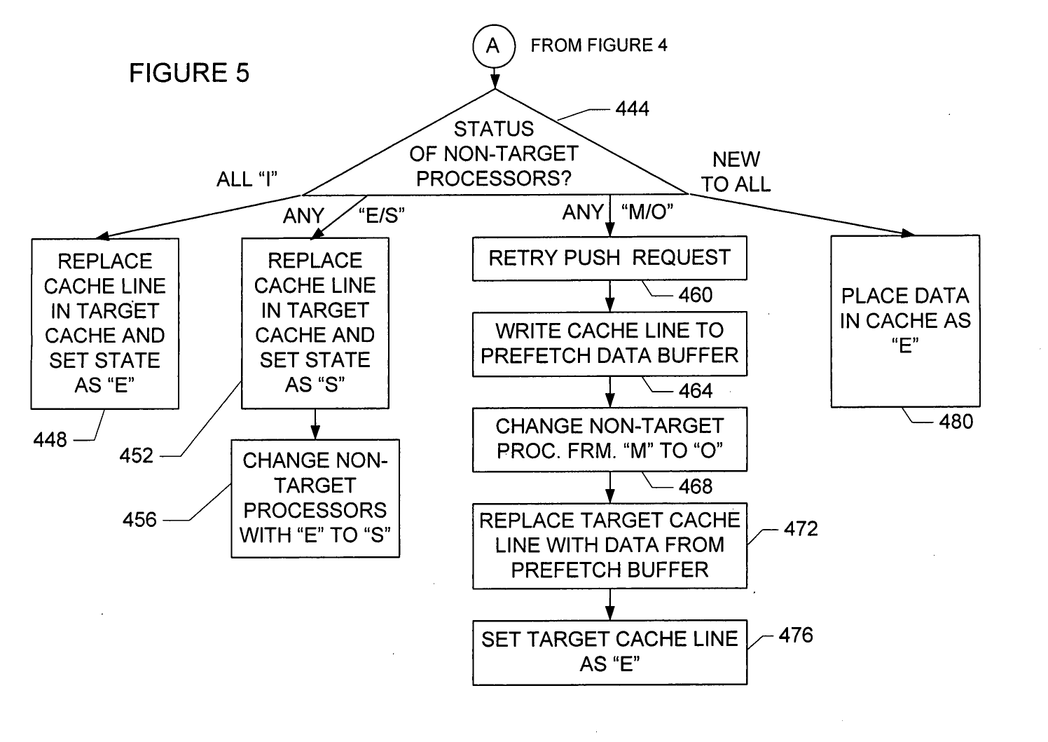

Similar to what is described along with FIG. 1, the push logic 152 may use any system interconnection bus transactions to push data into a cache of a targeted processor. If the bus has the “push” functionality, the push logic 152 may use such functionality to push the data. The targeted processor may claim the data from the bus, but may or may not actually place the data in its cache such that cache coherency among multiple processors is not disrupted. Whether the targeted processor will actually place the data in its cache depends not only on states of the relevant cache lines in the targeted processor's cache, but also on the states of corresponding cache lines in non-targeted processors' caches. A detailed description of how to maintain cache coherency when pushing data into a processor cache by a memory controller in a multiple-processor computing system will be discussed in connection with FIGS. 4 and 5.

FIGS. 4 and 5 illustrate an example process of using a memory controller to push data into a processor cache in a multiple-processor computing system. In block 402, each processor's memory access patterns (both spatially and temporarily) may be analyzed. In block 408, a prediction of each processor's future data requests may be made based on analysis results obtained in block 402. If multiple processors are collaborating with each other and performing the same task, a global prediction what data is likely needed by all the processors may be needed. In block 412, data which is likely to be requested by each processor according to the prediction made in block 408 may be moved from the memory to a buffer in the memory controller (e.g., prefetch data buffer 154 as shown in FIG. 3). In block 416, a request to push data desired by a processor into a cache associated with the processor (e.g., cache 120B as shown in FIG. 3) may be issued. A push request per cache line of data may be issued. A push request may be sent out via a system interconnection bus and may reach all processors connected to the bus, but only a processor whose ID matches match the target ID included in the push request will respond to the push request. A targeted processor may or may not accept the push request.

In block 420, a decision whether a targeted processor accepts the push request issued in block 416 may be made. The “push” field of the cache line write transaction may be set (i.e., the “push” function is enabled) and the target ID may be included in the transaction. This cache line write transaction with “push” may be claimed by the processor if the processor's own ID matches the target ID in the transaction. If the targeted processor does not accept the push request, a retry instruction may be made in block 424 so that the push request may be reissued in block 416. If the targeted processor accepts the push request, the cache line of data to be pushed may be put on a bus, which connects the memory controller and the processor, as a write data transaction in block 428. Here it is assumed that write operation with “push” is executed as a split transaction having a request phase and data phase. However, it is possible to have an interconnect that supports immediate write operation with “push”, where the push data is provided during or immediately after the address (request) phase. Before deciding to place the claimed cache line into a cache of the targeted processor, measures need to be taken to ensure the cache coherency among all caches of the targeted processor and non-targeted processors.

In block 436, the cache of the targeted processor may be checked to see if the pushed cache line claimed from the bus is present. If the claimed cache line is present in the cache, on one hand, the state of the cache line in the cache may be further checked. If the state of the cache line is M, O, E, or S (i.e., a hit for the processor), the claimed cache line may be discarded by the targeted processor in block 440; and the state of the cache line in the cache remains unchanged. If the claimed cache line is new to the cache or if it is not new but the cache line in the cache has an I state, on the other hand, further actions are performed in block 444 of FIG. 5 to check whether the claimed cache line is new to any of the other caches, and to check the state of the cache line in any of the other caches if it is not new to any of the other caches.

If the claimed cache line is new to caches of all the non-targeted processors, the claimed cache line may be placed in the cache of the targeted processor with its state being set as E in block 480 of FIG. 5. If the claimed cache line is present in one or more caches of non-targeted processors, but states of the cache lines in all those caches are I, then the claimed cache line may be used to replace its corresponding cache line in the targeted processor cache with a new E state being set for the replaced cache line in block 448.

If the claimed cache line is present in a non-targeted processor cache with an E or S state and none of the non-targeted processors has the cache line in either M or O state, the claimed cache line may be used to replace its corresponding cache line in the targeted processor cache with an S state being set for the replaced cache line in block 452. In block 456, the state of the cache line in the non-targeted processor cache is changed from E to S.

If the claimed cache line is present with an M or O state in one non-targeted processor cache, this means that at least one non-targeted processor cache has a more updated version of the cache line than the memory. In this case, a request for retrying to issue a push request may be sent out in block 460. In block 464, the corresponding cache line with the M/O state may be written back from the non-targeted processor cache to a buffer in the memory controller (e.g., prefetch data buffer 154 as shown in FIG. 3). As a result of writing back, the state of the corresponding cache line with the M state in one non-targeted processor cache is changed from M to O in block 468. In block 472, the written back cache line from block 468 may be retrieved from the buffer in the memory controller and used to replace the corresponding cache line in the targeted processor cache. The state of the cache line replaced with the written back cache line in the targeted processor cache may be set as S in block 476.

Although a full cache line push is assumed in the above description, a person of ordinary skill in the art can appreciated the disclosed techniques may be readily made to apply to any partial cache line push.

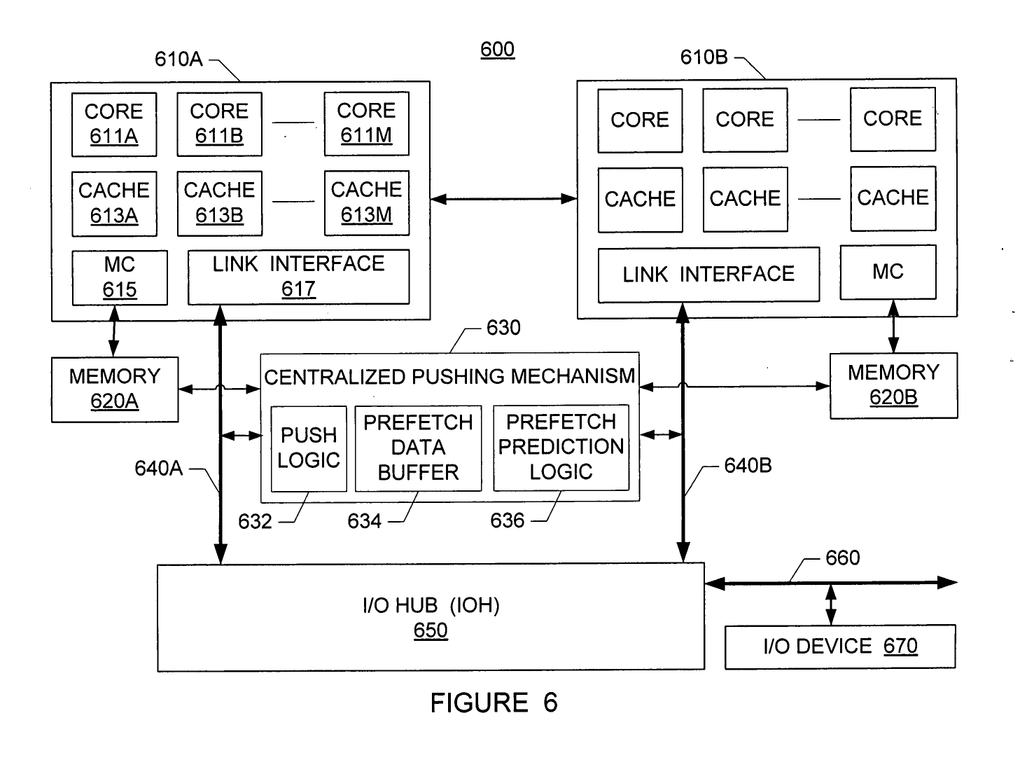

Although FIGS. 1 and 3 depict computing systems using a memory controller to push data into a processor cache, a person of ordinary skill in the art will appreciate that a variety of other arrangements may also be utilized. For example, a centralized pushing mechanism as shown in FIG. 6 may be used to achieve the same or similar purposes.

FIG. 6 depicts a computing system 600 of which a centralized pushing mechanism may be used to actively push data into a cache of a processor. The computing system 600 comprises two processors 610A and 610B, memories 620A and 620B, a centralized pushing mechanism 630, an I/O hub (IOH) 650, a Peripheral Component Interconnect (PCI) bus 660, and at least one I/O device 670 coupled to the PCI bus 660. Each processor (e.g., 610A) may comprise one or more processing cores, 611A, 611B, . . . , 611M. Each processing core may run a program which needs data from a memory (e.g., 620A or 620B). In one embodiment, each processing core may have its own cache such as 613A, 613B, . . . , 613M as shown in the figure. In another embodiment, some or all of the processing cores may share a cache. Typically, a processing core can access data in its cache more efficiently than it accesses data in memory 620A or 620B. Each processor (e.g., 610A) may also comprise a memory controller (e.g., 615) coupled to a memory (e.g., 620A) to control traffic to/from the memory. Additionally, a processor may comprise a link interface 617 to provide point-to-point connections (e.g., 640A and 640B) between the processor, the centralized pushing mechanism 630, and the IOH 650. Although FIG. 6 shows two processors, the system 600 may comprise only one processor or more than two processors.

The memories 620A and 620B both store data that are needed by processors or any other device included in the system 600. The IOH 650 provides an interface to input/output (I/O) devices in the system. The IOH may be coupled to a Peripheral Component Interconnect (PCI) bus 660. The I/O device 670 may be connected to the PCI bus. Although not shown, other devices may also be coupled to the PCI bus and the ICH.

The centralized pushing mechanism 630 may comprise push logic 632, a prefetch data buffer 634, and prefetch prediction logic 636. In the system 600, the prefetch prediction logic 636 may analyze memory access patterns (both temporarily and spatially) of all processing cores (e.g., 611A through 611M) in each processor (e.g., 610A and 610B), and may predict each processing core's future data requests based on its memory access patterns. Based on such predictions, data that is likely be requested by each processing core may be moved from a memory (e.g., 620A or 620B) and temporarily stored in the prefetch data buffer 634. The push logic 632 may issue a request to push the data from the prefetch data buffer 634 to a cache of a requesting processing core. One push request per cache line of data to be pushed may be issued. A push request including the identification of a target processing core (“target ID”) may be sent to all processing cores via the point-to-point connections (e.g., 640A or 640B), but only the targeted processing core whose identification matches the target ID needs to respond to the push request. If the targeted processing core accepts the push request, the push logic 632 may put the cache line on the point-to-point connections from which the targeted processing core may claim the cache line; otherwise, the push logic 632 may retry issuing the push request to the targeted processing core. When multiple processing cores are collaborating with each other and performing the same task, the prefetch prediction logic may make a global prediction what data is likely to be needed by those processing cores. Based on such a global prediction, data that is likely needed by those processors may be pushed to their caches by the push logic 632. Although the centralized pushing mechanism 630 is separate from the IOH 650 as shown in FIG. 6, the mechanism may be combined with the IOH in one circuitry or may be an integral part of the IOH in other embodiments.

Similar to what is described along with FIGS. 1 and 3, the push logic 632 may use any system interconnection (e.g., point-to-point connection) transactions to push data into a cache of a targeted processor. If the system interconnection has the “push” functionality, the push logic 632 may use such functionality to push the data. The targeted processing core may claim the data from the system interconnection, but may or may not actually place the data in its cache such that cache coherency among multiple processors is not disrupted. Whether the targeted processing core will actually place the data in its cache depends not only on states of the relevant cache lines in the targeted processor core's cache, but also on the states of corresponding cache lines in non-targeted processor cores' caches. An approach similar to that illustrated in FIGS. 4 and 5 may be used to maintain cache coherency in the system 600.

Although an example embodiment of the disclosed techniques is described with reference to diagrams in FIGS. 1-6, persons of ordinary skill in the art will readily appreciate that many other methods of implementing the present invention may alternatively be used. For example, the order of execution of the functional blocks or process procedures may be changed, and/or some of the functional blocks or process procedures described may be changed, eliminated, or combined.

In the preceding description, various aspects of the present disclosure have been described. For purposes of explanation, specific numbers, systems and configurations were set forth in order to provide a thorough understanding of the present disclosure. However, it is apparent to one skilled in the art having the benefit of this disclosure that the present disclosure may be practiced without the specific details. In other instances, well-known features, components, or modules were omitted, simplified, combined, or split in order not to obscure the present disclosure.

The disclosed techniques may have various design representations or formats for simulation, emulation, and fabrication of a design. Data representing a design may represent the design in a number of manners. First, as is useful in simulations, the hardware may be represented using a hardware description language or another functional description language which essentially provides a computerized model of how the designed hardware is expected to perform. The hardware model may be stored in a storage medium such as a computer memory so that the model may be simulated using simulation software that applies a particular test suite to the hardware model to determine if it indeed functions as intended. In some embodiments, the simulation software is not recorded, captured, or contained in the medium.

Additionally, a circuit level model with logic and/or transistor gates may be produced at some stages of the design process. This model may be similarly simulated, sometimes by dedicated hardware simulators that form the model using programmable logic. This type of simulation, taken a degree further, may be an emulation technique. In any case, re-configurable hardware is another embodiment that may involve a machine readable medium storing a model employing the disclosed techniques.

Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. Again, this data representing the integrated circuit embodies the techniques disclosed in that the circuitry or logic in the data can be simulated or fabricated to perform these techniques.

In any representation of the design, the data may be stored in any form of a computer readable medium or device (e.g., hard disk drive, floppy disk drive, read only memory (ROM), CD-ROM device, flash memory device, digital versatile disk (DVD), or other storage device). Embodiments of the disclosed techniques may also be considered to be implemented as a machine-readable storage medium storing bits describing the design or the particular part of the design. The storage medium may be sold in and of itself or used by others for further design or fabrication.

While this disclosure has been described with reference to illustrative embodiments, this description is not intended to be construed in a limiting sense. Various modifications of the illustrative embodiments, as well as other embodiments of the disclosure, which are apparent to persons skilled in the art to which the disclosure pertains are deemed to lie within the spirit and scope of the disclosure.

What is claimed is:

1. An apparatus for pushing data from a memory into a cache of a processing unit in a computing system, comprising:
request prediction logic to analyze memory access patterns by the processing unit and to predict data requests of the processing unit based on the memory access patterns; and
push logic to issue a push request per cache line of data predicted to be requested by the processing unit, and to send the cache line associated with the push request to the processing unit if the processing unit accepts the push request, the processing unit placing the cache line in the cache.

2. The apparatus of claim 1, further comprising a prefetch data buffer to temporarily store the data predicted to be requested by the processing unit, the data retrieved from the memory.

3. The apparatus of claim 1, wherein the computing system comprises at least one processor, each processor including at least one processing unit.

4. The apparatus of claim 1, wherein the request prediction logic analyzes memory access patterns by each processing unit in the computing system and to predict data requests of each processing unit based on the memory access patterns; and the push logic pushes data predicted to be requested by each processing unit to a cache of a targeted processing unit.

5. The apparatus of claim 1, wherein the computing system comprises a coherency protocol to ensure coherency among caches in the computing system when the request cache line is placed in the cache of the processing unit.

6. A computing system, comprising:
at least one processor, each processor including at least one processing unit associated with a cache;
at least one memory to store data accessible by each processing unit in the system; and
a centralized pushing mechanism to facilitate data traffic to and from the at least one memory, to predict data requests of each processing unit in the system, and to actively push data into a cache of a targeted processing unit in the at least one processor based on the predicted data requests of the targeted processing unit.

7. The computing system of claim 6, wherein a processing unit has faster access to data in a cache associated with the processing unit than to data in the at least one memory.

8. The computing system of claim 6, further comprising a cache coherency protocol to ensure coherency among caches in the computing system when the data predicted to be requested by the targeted cache is placed in the cache.

9. The computing system of claim 6, wherein the centralized pushing mechanism comprises:
request prediction logic to analyze memory access patterns by each processing unit in the system and to predict data requests of each processing unit based on the memory access patterns; and
push logic to issue a push request per cache line of data predicted to be requested by a processing unit, and to send the cache line associated with the push request to the processing unit if the processing unit accepts the push request.

10. The computing system of claim 9, further comprising a prefetch data buffer to temporarily store data predicted to be requested by a processing unit before the data is sent to the processing unit, the data retrieved from the memory.

11. The computing system of claim 6, wherein the at least one processor and the centralized pushing mechanism are coupled to a bus, the centralized pushing mechanism sending data to the targeted processing unit through bus write transactions.

12. The computing system of claim 11, wherein the bus comprises a push functionality and a cache line write transaction, the push functionality enabled during the cache line write transaction when the centralized pushing mechanism sends a cache line to a targeted processing unit through a cache line write transaction, wherein a cache line write transaction comprises an identification of the targeted processing unit.

13. The computing system of claim 12, wherein a cache line sent through a cache line write transaction is claimed by a processing unit whose identification matches the identification of the targeted processing unit in the transaction.

14. The computing system of claim 6, wherein the centralized pushing mechanism is a memory controller.

15. A method for using a centralized pushing mechanism to push data into a processor cache, comprising:
analyzing a memory access pattern by a processor;
predicting data requests of the processor based on the processor's memory access pattern;
issuing a push request for data predicted to be requested by the processor; and
pushing the data into a cache of the processor.

16. The method of claim 15, further comprising moving the data from a memory to a buffer in the centralized pushing mechanism before issuing the push request.

17. The method of claim 15, further comprising ensuring cache coherency when pushing the data into the cache of the processor.

18. The method of claim 15, wherein issuing the push request comprises issuing a push request for each cache line of the data predicted to be requested by the processor.

19. The method of claim 18, wherein pushing a cache line of data comprises:
determining if the processor accepts the push request;
if the processor accepts the push request,
sending the cache line to the processor as a bus transaction, and
claiming the cache line from the bus by the processor; and
otherwise,
retrying to issue the push request.

20. The method of claim 19, further comprising handling the cache line claimed from the bus to ensure cache coherency.

21. The method of claim 19, wherein sending the cache line to the processor as a bus transaction comprises using a cache line write transaction of the bus and enabling a push functionality of the cache line write transaction.

22. A method for using a centralized pushing mechanism to push data into a cache of a processing unit, comprising:
analyzing memory access patterns by each processing unit in a plurality of processors, each processor including at least one processing unit;
predicting data requests of each processing unit based on each processing unit's memory access pattern;
issuing at least one push request for data predicted to be requested by each processing unit; and
pushing data predicted to be requested by a processing unit into a cache of the processing unit.

23. The method of claim 22, wherein predicting data requests comprises predicting a common data request among multiple processing units in the plurality of processors.

24. The method of claim 22, further comprising moving the data predicted to be requested by each processing unit from a memory to a buffer in the centralized pushing unit before issuing the at least one push request.

25. The method of claim 22, wherein issuing the at least one push request comprises issuing a push request per each cache line of the data predicted to be requested by each processing unit, the push request including an identification of a targeted processing unit.

26. The method of claim 25, wherein pushing a cache line of data to a cache of a targeted processing unit comprises:
determining if the targeted processing unit accepts the push request;
if the targeted processing unit accepts the push request,
sending the cache line to the plurality of processors as a bus transaction, the bus transaction including an identification of a processing unit to which the cache line is sent, and
claiming the cache line from the bus by the targeted processor if the targeted processor's identification matches the identification of the processor to which the cache line is sent; and
otherwise,
retrying to issue the push request.

27. The method of claim 26, wherein sending the cache line to the plurality of processors as a bus transaction comprises using a cache line write transaction of the bus and enabling a push functionality of the cache line write transaction.

28. The method of claim 26, further comprising handling the claimed cache line to ensure coherency among caches of all processing units in the plurality of processors.

29. An article comprising a machine readable medium that stores data representing a centralized pushing mechanism comprising:
request prediction logic to analyze memory access patterns by at least one processing unit in a computing system and to predict data requests of the at least one processing unit based on the memory access patterns;
a prefetch data buffer to temporarily store data predicted to be requested by the at least one processing unit, the data retrieved from a memory; and
push logic to issue a push request per cache line of data predicted to be requested by the at least one processing unit, and to send the cache line associated with the push request to a targeted processing unit if the targeted processing unit accepts the push request, the targeted processing unit placing the cache line in the cache.

30. The article of claim 29, wherein the data representing the computing system comprises a hardware description language code.

31. The article of claim 29, wherein the data representing the computing system comprises data representing a plurality of mask layers string physical data representing the presence or absence of material at various locations of each of the plurality of mask layers.

32. An article comprising a machine readable medium having stored thereon data which, when accessed by a processor in conjunction with simulation routines, provides functionality of a centralized pushing mechanism including:
request prediction logic to analyze memory access patterns by at least one processing unit in a computing system and to predict data requests of the at least one processing unit based on the memory access patterns;
a prefetch data buffer to temporarily store data predicted to be requested by the at least one processing unit, the data retrieved from a memory; and
push logic to issue a push request per cache line of data predicted to be requested by the at least one processing unit, and to send the cache line associated with the push request to a targeted processing unit if the targeted processing unit accepts the push request, the targeted processing unit placing the cache line in the cache.

33. The article of claim 32, wherein the centralized pushing mechanism facilitates data traffic to and from a memory, and to actively push data into a cache of a targeted processing unit, the targeted processing unit having more efficient access to data in the cache than access to data in the memory.
